(19) United States
(12) Patent Application Publication
(10) Pub. No.: US 2008/0091628 A1
(43) Pub. Date: Apr. 17, 2008

(54) Cognitive architecture for learning, action, and perception

(76) Inventors: Narayan Srinivasa, Oak Park, CA (US); Deepak Khosia, Camarillo, CA (US)

Correspondence Address: TOPE-MCKAY & ASSOCIATES, 23852 PACIFIC COAST HIGHWAY #311, MALIBU, CA, 90265, US

(21) Appl. No.: 11/801,377

(22) Filed: May 9, 2007

Related U.S. Application Data
(60) Provisional application No. 60/838,434, filed on Aug. 16, 2006.

(51) Int. Cl. G06F 15/18

(52) U.S. Cl. 706/12

(57) ABSTRACT

The present invention relates to a learning system. The learning system comprises a sensory and perception module, a cognitive module, and an execution module. The sensory and perception module is configured to receive and process external sensory input from an external world and extract sensory-specific features from the external sensory input. The cognitive module is configured to receive the sensory-specific features and identify a current context based on the sensory-specific features. Based on the current context and features, the cognitive module learns, constructs, or recalls a set of action plans and evaluates the set of action plans against any previously known action plans in a related context. Based on the evaluation, the cognitive module selects the most appropriate action plan given the current context. The execution module is configured to carry out the action plan.

### PRIORITY CLAIM

The present application is a non-provisional patent application, claiming the benefit of priority of U.S. Provisional Application No. 60/838,434, filed on Aug. 16, 2006, entitled, “BICA-LEAP: A Biologically Inspired Cognitive Architecture for Learning, Action and Perception.”

### FIELD OF INVENTION

The present invention relates to a learning system and, more particularly, to an artificial intelligence system for learning, action, and perception that integrates perception, memory, planning, decision-making, action, self-learning, and affect to address the full range of human cognition.

### BACKGROUND OF INVENTION

Artificial Intelligence (AI) is a branch of computer science that deals with intelligent behavior, learning, and adaptation in machines. Research in AI is traditionally concerned with producing machines to automate tasks requiring intelligent behavior. While many researchers have attempted to create AI systems, there is very limited prior work on comprehensive cognitive architectures.

For example, there is no comprehensive brain-like architecture that links physiology with anatomy and the derived functionalities. However, numerous neuroscience-inspired modal architectures have been proposed, such as those cited as reference numbers 7, 9, 18, 40, 42, 88, 98, 116, 128, 143, and 152-156 (See the “List of Cited References” below). Functional characterizations of these architectures typically use aspects from very different levels of biologically-inspired descriptions. For example, connectionists often base their architectural proposal on some abstract properties assumed to be involved in the information processing of the brain. Others are more biological in terms of their underlying modeling; however, they do not explain the wide body of experimental data.

A description of psychology-based architectures is provided since these represent the state of the art in cognitive architectures. While several cognitive architectures have been proposed and implemented, two popular and commonly used architectures are ACT-R (see literature reference no. 156) and Soar (see literature reference no. 158). ACT-R is a parallel-matching, serial-firing production system with a psychologically motivated conflict resolution strategy. Soar is a parallel-matching, parallel-firing rule-based system where the rules represent both procedural and declarative knowledge. Several traditional features of ACT-R and Soar are described below:
Modeling: It is not clear if the human cognitive processes can be comprehensively modeled as a production system. Even if the processes were, the production system would lack the capability of modeling flexible behavior. For example, ACT-R instantiates only rules that match the current goal and these have complete control of problem solving, including when to surrender control. Hence ACT-R cannot respond to dynamic internal or external changes.
Representation and self-organization: Prior models use rigid propositional representations and share an inviolable structural constraint.
Comprehensiveness: Traditional cognitive architectures are not comprehensive. Such architectures lack detailed theories of speech perception or production as well as mechanisms for perceptual recognition, mental imagery, emotion, and motivation.
Integration of perception and problem solving: Typically, perception is a peripheral activity that is treated separately from problem solving in traditional cognitive architectures. An overall comprehensive architecture must be integrative of these. For example, the architecture must address how perception is related to representation change in problem-solving and how linguistic structures may affect problem-solving. BICA-LEAP explores the integration of perception, problem solving and natural language at a deeper level.
Implementation: ACT-R has neither been used to reason about concurrent actions nor in hierarchy. It is difficult, although not impossible, to implement a hierarchy of behaviors in Soar. Therefore, a need exists for a more flexible arrangement of goals that permits multiple abstract behaviors that can share implementations.

Implementing such a complex system of neural-like components is a major challenge and, as such, there is very little existing work to draw on. Hecht-Nielsen (see literature reference no. 159) and Lansner (see literature reference no. 160) have built large systems, though not as all-encompassing in size and complexity as the present invention. Additionally, Sporns' (see literature reference no. 161) work on motifs in brain networks is a mathematical optimization technique to obtain network topologies that resemble brain networks across a spectrum of structural measures. Further, Andersen (see literature reference no. 162) has suggested building brain-like computers via software development using models at a level between low-level network of attractor networks and associatively linked networks. However, it is not clear how the above are neuromorphic architectures or that they support the large body of neuroscience data.

Research in neuroscience and cognitive psychology over the last several decades has made remarkable progress in unraveling the mysteries of the human mind. However, the prior art is still quite far from building and integrating computational models of the entire gamut of human-like cognitive capabilities. As discussed above, very limited prior art exists in building an integrated and comprehensive architecture.

A challenge present in the art is to develop a cognitive architecture that is comprehensive and covers the full range of human cognition. Current approaches are not able to provide such a comprehensive architecture. Architectures developed to-date typically solve single and multiple modal problems that are highly specialized in function and design. In addition, there are often very different underlying theories and architectures for the same cognitive modal problem. This presents a significant challenge in seamlessly integrating these disparate theories into a comprehensive architecture such that all cognitive functionalities can be addressed. Computational design and implementation of these architectures is another major challenge. These architectures must be amenable to implementation as stand-alone or hybrid neuro-AI architectures via software/hardware and evaluation in follow-on phases.

Thus, a continuing need exists for an architecture that seamlessly integrates models firmly rooted in neural principles, mechanisms, and computations for which there is supporting neuro-physiological data and which link to human behaviors based on a large body of psychophysical data.

### SUMMARY OF INVENTION

The present invention relates to a learning system. The learning system comprises a sensory and perception module, a cognitive module, and an execution module. The sensory and perception module is operative to receive and process an external sensory input from an external world and extract sensory-specific features from the external sensory input. The cognitive module is operative to receive the sensory-specific features and identify a current context based on the sensory-specific features, and, based on the current context and features, learn, construct, or recall a set of action plans and evaluate the set of action plans against any previously known action plans in a related context and, based on the evaluation, selecting the most appropriate action plan given the current context. The execution module is operative to carry out the action plan.

The cognitive module further comprises an object and event learning system and a novelty detection, search, and navigation module. The object and event learning system is operative to use the sensory-specific features to classify the features as objects and events. Additionally, the novelty detection, search, and navigation module is operative to determine if the sensory-specific features match previously known events and objects. If they do not match, then the object and event learning system stores the features as new objects and events. Alternatively, if they do match, then the object and event learning system stores the features as updated features corresponding to known objects and events.

In another aspect, the cognitive module further comprises a spatial representation module. The spatial representation module is operative to establish space and time attributes for the objects and events. The spatial representation module is also operative to transmit the space and time attributes to the novelty detection, search, and navigation module, with the novelty detection, search, and navigation module being operative to use the space and time attributes to construct a spatial map of the external world.

In yet another aspect, the cognitive module further comprises an internal valuation module to evaluate a value of the sensory-specific features and the current context. The internal valuation module is operative to generate a status of internal states of the system and given the current context, associate the sensory-specific features to the internal states as improving or degrading the internal state.

Additionally, the cognitive module further comprises an external valuation module. The external valuation module is operative to establish an action value based purely on the objects and events. The action value is positively correlated with action plans that are rewarding to the system based on any previously known action plans. The external valuation module is also operative to learn from the positive correlation to assess the value of future action plans and scale a speed at which the action plans are executed by the execution module.

In another aspect, the cognitive module further comprises a behavior planner module that is operative to receive information about the objects and events, the space and time attributes for the objects and events, and the spatial map to learn, construct, or recall a set of action plans, and use the status of the internal state to sub-select the most appropriate action from the set of action plans. The external valuation module is also operative to open a gate in a manner proportional to the action value such that only action plans that exceed a predetermined action value level are allowed to proceed to the execution module.

In yet another aspect, the execution module is operative to receive the action plans and order them in a queue sequentially according to their action value; receive inputs to determine the speed at which to execute each action plan; sequentially execute the action plans according to the order of the queue and the determined speed; and learn the timing of the sequential execution for any given action plan in order to increase efficiency when executing similar action plans in the future.

The present invention also includes at least one motor for carrying out the action plan.

Additionally, the sensory and perception module includes a sensor for sensing and generating the external sensory inputs. The sensor is selected from a group consisting of a somatic sensor, an auditory sensor, and a visual sensor.

Finally, as can be appreciated by one skilled in the art, the present invention also comprises a computer program product and method. The method includes a plurality of acts for carrying out the operations described herein. The computer program product comprises computer-readable instruction means stored on a computer-readable medium. The instruction means are executable by a computer for causing the computer to perform the described operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of an artificial intelligence system according to the present invention;

FIG. 2 is an illustration of a computer program product according to the present invention;

FIG. 3 is an illustration of the neuromorphic architecture according to the present invention;

FIG. 4 is an illustration of the architecture of a sensory and perception module according to the present invention;

FIG. 5A is an illustration of the architecture of a cognitive module according to the present invention;

FIG. 5B is a table mapping various cognitive functionalities with structures and pathways as related to the architecture of the present invention; and

FIG. 6 is an illustration of the architecture of an execution module according to the present invention.

### DETAILED DESCRIPTION

The present invention relates to a learning system, and more particularly, to an artificial intelligence system for learning, action, and perception that integrates perception, memory, planning, decision-making, action, self-learning, and affect to address the full range of human cognition. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a glossary of terms and table of abbreviations that are used in the description and claims is presented. Following the glossary, a description of various principal aspects of the present invention is provided. Subsequently, an introduction provides the reader with a general understanding of the present invention. Next, details of the present invention are provided to give an understanding of the specific aspects. Finally, a summary is provided as a synopsis of the present invention.

### (1) LIST OF CITED LITERATURE REFERENCES

The following references are cited throughout this application. For clarity and convenience, the references are listed herein as a central resource for the reader. The following references are hereby incorporated by reference as though fully included herein. The references are cited in the application by referring to the corresponding literature reference number.
1. S. Grossberg, “Cortical dynamics of the three-dimensional form, color, and brightness perception: I. Monocular theory,” Perception and Psychophysics, 41, 87-116, 1987.
2. S. Grossberg, “Cortical dynamics of the three-dimensional form, color, and brightness perception: II. Binocular theory,” Perception and Psychophysics, 41, 117-158, 1987.
3. S. Grossberg and E. Mingolla, “Neural dynamics of perceptual grouping: Textures, boundaries, and emergent segmentations,” Perception and Psychophysics, 38, 141-171, 1985.
4. S. Grossberg and E. Mingolla, “Neural dynamics of surface perception: Boundary webs, illuminants, and shape-from-shading,” CVGIP, 37, 116-165, 1987.
5. R. Desimone, “Neural circuits for visual attention in the primate brain,” In G. A. Carpenter and S. Grossberg (Eds.), Neural Networks for vision and image processing (pp. 343-364). Cambridge, Mass., MIT Press, 1992.
6. G. A. Carpenter and S. Grossberg, Pattern recognition by self-organizing neural networks, Cambridge, Mass., MIT Press, 1991.
7. S. Grossberg, “The complementary brain: unifying brain dynamics and modularity,” Trends in Cognitive Sciences, 4, 233-246, 2000.
8. S. Grossberg, “How does the cerebral cortex work? Learning, attention, and grouping by the laminar circuits of visual cortex,” Spatial Vision, 12, 163-187, 1999.
9. R. D. S. Raizada and S. Grossberg, “Towards a theory of the laminar architecture of cerebral cortex: Computational clues from the visual system,” Cerebral Cortex, 13, 100-113, 2003.
10. F. H. Guenther, “A neural network model of speech acquisition and motor equivalent speech production,” Biological Cybernetics, 72, 43-53, 1994.
11. S. Grossberg, S., “Resonant neural dynamics of speech perception,” Journal of Phonetics, vol. 31, pp. 423-445, 2003.
12. G. A. Carpenter, S. Grossberg, and C. Mehanian, “Invariant recognition of cluttered scenes by a self-organizing ART architecture: CORT-X boundary segmentation,” Neural Networks, 2,169-181, 1989.
13. S. Grossberg and P. D. L. Howe, “A laminar cortical model of stereopsis and three-dimensional surface perception,” Vision Research, 43(7), 801-829, 2003.
14. S. Grossberg, E. Mingolla, and W. D. Ross, “A neural theory of attentive vision search: interactions of boundary, surface, spatial, and object representations,” Psychological Review, 101(3), 470-489, 1994.
15. S. Grossberg, I. Boardman, and M. Cohen, “Neural dynamics of variable-rate speech categorization,” Journal of Experimental Psychology, 23:418-503, 1997.
16. S. Grossberg and C. W. Myers, “The resonant dynamics of speech perception: Interword integration and duration-dependent backward effects,” Psychological Review, (4), 735-767, 2000.
17. G. Bradski and S. Grossberg, “Fast-Learning VIEWNET Architectures for Recognizing Three-dimensional Objects from Multiple Two-dimensional views,” Neural Networks, 8(7/8), 1053-1080, 1995.
18. J. W. Brown, D. Bullock, and S. Grossberg, “How laminar frontal cortex and basal ganglia circuits interact to control planned and reactive saccades,” Neural Networks, 17, 471-510, 2004.
19. S. Grossberg, K. K. Govindarajan, L. L. Wyse, and M. A. Cohen, “ARTSTREAM: a neural network model of auditory scene analysis and source segregation,” Neural Networks, 17(4), 511-536, 2004.
20. E. A. DeYoe, D. C. Van Essen, “Concurrent processing streams in monkey visual cortex,” Trends in Neurosciences, vol. 11, pp. 219-226, 1988.
21. P. Gaudiano and S. Grossberg, “Vector Associative Maps: Unsupervised real-time error-based learning and control of movement trajectories,” Neural Networks, vol. 4, pp. 147-183, 1991.
22. D. Bullock and S. Grossberg, “The VITE model: A neural command circuit for generating arm and articulator trajectories,” Dynamic Patterns in complex systems, pp. 305-326, World Scientific Publishers, Singapore, 1991.
23. S. Grossberg and J. W. L. Merrill, “The Hippocampus and cerebellum in adaptively timed learning, recognition and movement,” Journal of Cognitive Neuroscience, vol. 8, pp. 257-277, 1996.
24. S. Grossberg, The Adaptive Brain, vol. 11, Elsevier, North Holland, 1987.
25. P. R. Roelfsema, V. H. F. Lamme, H. Spekreijse, “Object-based attention in primary visual cortex of the macaque monkey,” Nature, vol. 395, pp. 376-381, 1998.
26. P. R. Roelfsema, and H. Spekreijse, “The representation of erroneously perceived stimuli in the primary visual cortex,” Neuron, vol. 31, pp. 853-863, 2001.
27. D. H. Hubel and T. N. Wiesel, “Functional architecture of macaque monkey visual cortex, Proc. Royal Society of London, vol. 198, pp 1-59, 1977.
28. S. Grossberg, “Cortical Dynamics of three-dimensional figure-ground perception of two-dimensional pictures,” Psychological Review, vol. 104, pp. 618-658, 1997.
29. L. Ohzawa, G. C. DeAngelis, R. D. Freeman, “Stereoscopic depth discrimination by the visual cortex: Neurons ideally suited as disparity detectors,” Science, vol. 249, pp. 1037-1041, 1990.
30. R. von der Heydt, P. Hanny, M. R. Dursteler, “The role of orientation disparity in stereoscopic perception and the development of binocular correspondence,” in Advances in Physiological Science, Sensory Functions, Pergamon Press, 1981.
31. S. Grossberg, “3-D vision and figure-ground separation by visual cortex,” Perception and Psychophysics, vol. 55, pp. 48-120, 1994.
32. N. K. Logothetis, P. H. Schiller, E. R. Charles and A. C. Hulbert, “Perceptual deficits and the activity of the color-opponent and broad-band pathways at isoluminance, Science, vol. 247, pp. 214-217, 1990.
33. H. Wallach, On Perception, Quadrangle Press, 1976.
34. J. Chey, S. Grossberg, and E. Mingolla, “Neural Dynamics of motion grouping: From aperture ambiguity to object speed and direction,” Journal Optical Society of America, vol. 14, pp. 2570-2594, 1997.
35. L. G. Ungerleider and M. Mishkin, “Two cortical visual systems: Separation of appearance and location of objects,” in Analysis of Visual Behavior, pp. 549-586, MIT Press, 1982.
36. M. Mishkin, L. G. Ungerleider and K. A. Macko, “Object vision and spatial vision: Two cortical pathways,” Trends in Neurosciences, vol. 6, pp. 414-417, 1983.
37. M. A. Goodale and D. Milner, “Separate visual pathways for perception and action,” Trends in Neurosciences, vol. 15, pp. 10-25, 1992.
38. S. Grossberg and M. Rudd, “Cortical dynamics of visual motion perception: Short-range and long-range apparent motion,” Psychological Review, vol. 99, pp. 78-121, 1992.
39. G. A. Carpenter, S. Grossberg, and G. W. Lesher, “The What-and-Where Filter,” Computer Vision ad Image Understanding, vol. 69, no. 1, pp. 1-22, 1998.
40. S. Grossberg, “The link between brain learning, attention, and consciousness, Consciousness and Cognition, vol. 8, pp. 1-44, 1999.
41. A. M. Sillito, H. E. Jones, G. L. Gerstein, and D. C. West, “Feature-linked synchronization of thalamic relay cell firing induced by feedback from the visual cortex,” Nature, vol. 369, pp. 479-482, 1994.
42. G. A. Carpenter, S. Grossberg, “A massively parallel architecture for a self-organizing neural pattern recognition machine,” Computer Vision, Graphics and Image Processing, vol. 37, pp. 54-115, 1987.
43. G. A. Carpenter, S. Grossberg, “ART2: Stable self-organization of pattern recognition codes for analog input patterns,” Applied Optics, vol. 26, pp. 4919-4930, 1987.
44. G. A. Carpenter and S. Grossberg, “ART3: Hierarchical search using chemical transmitters in self-organizing pattern recognition architectures,” Neural Networks, vol. 3, pp. 129-152, 1990.
45. G. A. Carpenter, S. Grossberg, J. H. Reynolds, “ARTMAP: Supervised real-time learning and classification of nonstationary data by self-organizing neural network,” Neural Networks, vol. 4, pp. 1330-1336, 1995.
46. G. A. Carpenter and W. D. Ross, “ART-EMAP: A neural network architecture for object recognition by evidence accumulation,” IEEE Transactions on Neural Networks, vol. 6, pp. 805-818, 1995.
47. J. S. Bruner, The pathology of memory, Academic Press, New York, 1969.
48. M. Mishkin, “Memory in monkeys severely impaired by combined but not separate removal of the amygdala and hippocampus,” Nature, vol. 273, pp. 297-298, 1978.
49. M. Mishkin and T. Appenzeller, “The anatomy of memory,” Scientific American, vol. 256, pp. 80-89, 1987.
50. M. Mishkin, B. Malamut, and J. Bachevalier, “Memories and Habits: Two neural systems,” The neurobiology of learning and memory, pp. 287-296, New York, Guilford Press, 1984.
51. W. C. Drevets, H. Burton, and M. E. Raichle, “Blood flow changes in human somatosensory cortex during anticipated stimulation,” Nature, 373, 249, 1995.
52. L. R. Squire, and N. J. Cohen, “Human memory and amnesia,” In Neurobiology of learning and memory, New York, 1984.
53. L. R. Squire, and S. Zola-Morgan, “The medial temporal lobe memory system,” Science, vol. 253, pp. 1380-1386, 1991.
54. Ryle, G., The concept of mind, Hutchinson Press, 1949.
55. H. Eichenbaum, T. Otto, and N. J. Cohen, “Two functional components of the hippocampal memory system,” Behavioral and Brain Sciences, vol. 17, 449-472, 1994.
56. Y. R. Asfour, G. A. Carpenter, and S. Grossberg, “Landsat image segmentation using the fuzzy ARTMAP neural network. Technical Report CAS/CNS-TR-95-004, Boston University. In Proceedings of the world congress on neural networks, Washington, 1995.
57. Y. R. Asfour, G. A. Carpenter, S. Grossberg, and G. Lesher, “Fusion ARTMAP: A neural network architecture for multi-channel data fusion and classification,” Proceedings of the world congress on neural networks, vol. II, pp. 210-215, Hillsdale, N.J.: Erlbaum Associates, 1993.
58. G. A. Carpenter, M. A. Rubin, & W. W. Streilein, “ARTMAP-FD: Familiarity discrimination applied to radar target recognition,” Proceedings of the International Conference on Neural Networks (ICNN'97), 3, Piscataway, N.J.: IEEE Press, 1459-1464, 1997. Technical Report CAS/CNS TR-96-032, Boston, Mass.: Boston University.
59. G. A. Carpenter, and N. Markuzon, “ARTMAP-IC and medical diagnosis: Instance counting and inconsistent cases. Neural Networks, vol. 11, pp. 323-336, 1998.
60. G. A. Carpenter & W. W. Streilein, “ARTMAP-FTR: A neural network for fusion target recognition, with application to sonar classification,” AeroSense: Proceedings of SPIE's 12th Annual Symposium on Aerospace/Defense Sensing, Simulation, and Control. Orlando, Apr. 13-17, 1998.
61. G. A. Carpenter, B. Milenova, & B. Noeske, “dARTMAP: A neural network for fast distributed supervised learning,” Neural Networks, vol. 11, 793-813, 1998.
62. G. A. Carpenter, G. A. & F. D. M. Wilson, “ARTMAP-DS: Pattern discrimination by discounting similarities,” In W. Gerstner, A. Germond, M. Hasler, & J.-D. Nicoud (Eds.), Proceedings of the International Conference on Artificial Neural Networks (ICANN'97), Berlin: Springer-Verlag, 607-612, 1997.
63. S. Martens, P. Gaudiano, & G. A. Carpenter, “Mobile robot sensor fusion with fuzzy ARTMAP,” Proceedings of the 1998 IEEE International Symposium on Computational Intelligence in Robotics and Automation (ISIC/CIRA/ISAS'98), Piscataway, N.J.: IEEE Press, 307-312, 1998.
64. I. A. Bachelder, A. M. Waxman, and M. Seibert, “A neural system for mobile robot visual place learning and recognition,” In Proceedings of the world congress on neural networks, vol. I, pp. 512-517, Hillsdale, N.J.: Erlbaum Associates, 1993.
65. A. A. Baloch, and A. M. Waxman, “Visual learning, adaptive expectations, and behavioral conditioning of the mobile robot MAVIN,” Neural Networks, vol. 4, pp. 271-302, 1991.
66. G. A. Carpenter and S. Grossberg, “Fuzzy ARTMAP: Supervised learning, recognition and prediction by a self-organizing neural network,” IEEE Communications Magazine, vol. 30, 38-49, 1992.
67. G. A. Carpenter, S. Grossberg, and J. H. Reynolds, “A fuzzy ARTMAP nonparametric probability estimator for nonstationary pattern recognition,” IEEE Transactions on Neural Networks, vol. 6, 1330-1336, 1995.
68. G. A. Carpenter and A-H. Tan, “Rule extraction: From neural architecture to symbolic representation,” Connection Science, vol. 7, pp. 3-27, 1995.
69. T. P. Caudell, S. D. G. Smith, R. Escobedo, and M. Anderson, (1994), “NIRS: Large-scale ART 1 neural architectures for engineering design retrieval,” Neural Networks, vol. 7, 1339-1350, 1994.
70. A. Dubrawski, and J. L. Crowley, “Learning locomotion reflexes: A self-supervised neural system for a mobile robot,” Robotics and Autonomous Systems, vol. 12, pp. 133-142, 1994.
71. R. O. Gjerdingen. “Categorization of musical patterns by self-organizing neuron like networks,” Music Perception, vol. 7, pp. 339-370, 1990.
72: P. Goodman, V. Kaburlasos, D. Egbert, G. A. Carpenter, S. Grossberg, J. H. Reynolds, K. Hammermeister, G. Marshall, and F. Grover, “Fuzzy ARTMAP neural network prediction of heart surgery mortality,” In G. A. Carpenter and S. Grossberg (Eds.), Neural networks for learning, recognition, and control, Tyngsboro, Mass.: Wang Institute of Boston University, p. 48, 1992.
73. F. Ham, F. and S. Han, “Quantitative study of ARS complex using fuzzy ARTMAP and MIT/BIH arrhythmia database,” In Proceedings of the world congress on neural networks, vol. I, pp. 207-211, Hillsdale, N.J.: Erlbaum Associates, 1993.
74. R. M. Harvey, “Nursing diagnostics by computers: An application of neural networks,” Nursing Diagnostics, vol. 4, pp. 26-34, 1993.
75. J. Kasperkiewicz, J. Racz, and A. Dubrawski, “HPC strength prediction using artificial neural networks for development of diagnostic monitoring system in nuclear plants,” ASCE Journal of Computing in Civil Engineering, 1994.
76. S. Keyvan, A. Durg, and L. Rabelo, “Application of artificial neural networks for development of diagnostic monitoring system in nuclear plants,” Transactions of the American Nuclear Society, vol. 1, pp. 515-522, 1993.
77. B. Metha, L. Vij, and L. Rabelo, “Prediction of secondary structures of proteins using fuzzy ARTMAP,” In Proceedings of the world congress on neural networks, vol. I, pp. 228-232, Hillsdale, N.J.: Erlbaum Associates, 1993.
78. M. M. Moya, M. W. Koch, and L. D. Hostetler, “One-class classifier networks for target recognition applications,” In Proceedings of the world congress on neural networks, vol. III, pp. 797-801, Hillsdale, N.J.: Erlbaum Associates, 1993.
79. M. Seibert, and A. M. Waxman, “Adaptive 3-D object recognition from multiple views,” IEEE Transactions on Pattern Analysis and Machine Intelligence, vol. 14, 107-124, 1992.
80. Y. Suzuki, Y. Abe, and K. Ono, “Self-organizing QRS wave recognition system in ECG using ART 2. In Proceedings of the world congress on neural networks, IV, pp. 39-42. Hillsdale, N.J.: Erlbaum Associates, 1994.
81. D. Wienke, P. Xie, and P. K. Hopke, “An adaptive resonance theory based artificial neural network (ART 2A) for rapid identification of airborne particle shapes from their scanning electron microscopy images,” Chemometrics and Intelligent Laboratory Systems, 1994.
82. N. Srinivasa and J. Ziegert, “Automated Measurement and Compensation of Thermally Induced Error Maps in Machine Tools,” Precision Engineering, vol. 19, no. 2/3, pp. 112-132, October/November 1996.
83. N. Srinivasa, and M. Jouaneh, “An Invariant Pattern Recognition Machine Using a Modified ART Architecture,” IEEE Trans. on Systems, Man and Cybernetics, pp. 335-341, September/October 1993.
84. N. Srinivasa and M. Jouaneh, “A Neural Network Model for Invariant Pattern Recognition,” IEEE Trans. on Signal Processing, pp. 1595-1599, June 1992.
85. B. Perrin, N. Ahuja and N. Srinivasa, “Learning Multiscale Image Models of Object Classes,” Lecture Notes in Computer Vision, vol. 1352, pp. 323-331, Springer-Verlag, January, 1998.
86. N. Srinivasa and J. Ziegert, “Prediction of Thermally Induced Time-Variant Machine Tool Error Maps Using a Fuzzy ARTMAP Neural Network,” ASME Journal of Manufacturing Science and Engineering, vol. 119, pp. 623-630, November, 1997.
87. N. Srinivasa, “Learning and Generalization of Noisy Mappings Using a Modified PROBART Neural Network,” IEEE Trans. on Signal Processing, vol. 45, no. 10, pp. 2533-2550, October, 1997.
88. N. Srinivasa and N. Ahuja, “A Topological and Temporal Correlator Network for Spatio-Temporal Pattern Recognition and Recall,” IEEE Transactions on Neural Networks, vol. 10, no. 2, pp. 356-371, March 1999.
89. N. Srinivasa and S. Medasani, “Active Fuzzy Clustering for Collaborative Filtering,” IEEE International Conference on Fuzzy Systems-FUZZIEEE, vol. 3, pp. 1697-1702, Budapest, Hungary, 2004.
90. S. Medasani, N. Srinivasa and Y. Owechko, “Active Learning System for Object Fingerprinting,” International Joint Conference on Neural Networks-IJCNN, Budapest, vol. 1, pp. 345-350, Budapest, Hungary, 2004.
91. Y. Owechko, S. Medasani and N. Srinivasa, “Robust Confirmatory Target Identification Using Active Learning,” Sixth Annual EOSTN Symposium, Dallas, Tex., May 2003.
92. N. Srinivasa and M. Jouaneh, “An Investigation of Surface Roughness Characterization Using an ART2 Neural Network,” In Symposium on Sensors, Controls and Quality Issues in Manufacturing, ASME Winter Annual Meeting, PED vol. 55, pp. 307-318, 1991, Atlanta, Ga.
93. D. Greve, S. Grossberg, F. H. Guenther, and D. Bullock, “Neural Representations for Sensory Motor control, I: Head-centered 3-D target positions from opponent eye-commands, Acta Psychologica, vol. 82, pp. 115-138, 1993.
94. Guenther, F. H., Bullock, D., Greve, D. and Grossberg, S., “Neural representations for sensory-motor control, III: Learning a body-centered representation of 3-D target position,” J. Cognitive. Neurosciences, vol. 6, 341-358, 1994.
95. J. M. Foley, “Binocular distance perception,” Psychological. Review, vol. 87, pp. 411-434, 1980.
96. P. Grobstein, “Directed movement in the frog: A closer look at a central representation of spatial location,” in Visual Structure and Integrated Functions (Arbib, M. A. and Ewert, J.-P., eds.), pp. 125-138, Springer-Verlag, 1991.
97. H. Sakata, H. Shibutani, and K. Kawano, “Spatial properties of visual fixation neurons in posterior parietal association cortex of the monkey,” J Neurophysiology, vol. 43, pp. 654-1672, 1980.
98. D. Bullock, S. Grossberg, and F. H. Guenther, “A self-organizing neural model of motor equivalent reaching and tool use by a multijoint arm,” Journal of Cognitive Neuroscience, vol. 5, pp. 408-435, 1993.
99. D. Bullock, and S. Grossberg, “VITE and FLETE: Neural modules for trajectory formation and tension control,” in Volitional Action, pp. 253-297, North-Holland, Amsterdam, 1989.
100. A. H. Fagg and M. A. Arbib, “Modeling parietal-premotor interactions in primate control of grasping,” Neural Networks, vol. 11, no. 7-8, pp. 1277-1303, 1998.
101. A. Ulloa and D. Bullock, “A Neural Network simulating human reach-grasp coordination by continuous updating of vector positioning commands,” Neural Networks, vol. 16, pp. 1141-1160, 2003.
102. A. Ulloa, D. Bullock and B. J. Rhodes, “Adaptive force generation for precision-grip lifting by a spectral timing model of the cerebellum,” Neural Networks, vol. 16, pp. 521-528, 2003.
103. S. Grossberg. “A theory of human memory: Self-organization and performance of sensory-motor codes, maps, and plans,” In R. Rosen and F. Snell (Eds.), Progress in theoretical biology, Volume 5. New York: Academic Press, 1978. Reprinted in S. Grossberg, Studies of mind and brain, Boston: Reidel Press, 1982.
104. G. Bradski, and S. Grossberg, “A neural architecture for 3-D object recognition from multiple 2-D views. In Proceedings of the world congress on neural networks, vol. IV, pp. 211-219, Hillsdale, N.J.: Erlbaum Associates, 1994.
105. G. Bradski, G. A. Carpenter, and S. Grossberg, “Working memory networks for learning temporal order with application to 3-D visual object recognition,” Neural Computation, vol. 4, pp. 270-286, 1992.
106. M. A. Cohen, and S. Grossberg, “Neural dynamics of speech and language coding: Developmental programs, perceptual grouping, and competition for short term memory,” Human Neurobiology, vol. 5, pp. 1-22, 1986.
107. M. A. Cohen, S. Grossberg, “Masking Fields: A massively parallel neural architecture for learning, recognizing, and predicting multiple groupings of patterned data,” Applied Optics, vol. 26, pp. 1866-1891, 1987.
108. S. Grossberg, S. and G. O. Stone, G. O., “Neural dynamics of word recognition and recall: Attentional priming, learning, and resonance. Psychological Review, vol. 93, pp. 46-74, 1986.
109. S. Grossberg, S. and G. O. Stone, “Neural dynamics of attention switching and temporal order information in short term memory,” Memory and Cognition, vol. 14, 451-468, 1986.
110. G. Bradski, G. A. Carpenter, and S. Grossberg, “STORE working memory networks for storage and recall of arbitrary temporal sequences,” Biological Cybernetics, vol. 71, pp. 469-480, 1994.
111. P. S. Goldman-Rakic, “The issue of memory in the study of prefrontal function,” In A. M. Thierry, J. Glowsinski, P. S. Goldman-Rakic, and Y. Christen (Eds.), Motor and cognitive functions of the prefrontal cortex, New York: Springer-Verlag, pp. 112-121, 1994.
112. L. Itti, C. Koch and E. Neibur, “A Model of Saliency-Based Visual Attention for Rapid Scene Analysis,” IEEE Transactions on Pattern Analysis and Machine Intelligence, vol. 20, no. 11, pp. 1254-1259, 1988.
113. L. Itti, and C. Koch, “Feature combination strategies for saliency-based visual attention systems,” Journal of Electronic Imaging, vol. 10, no. 1, pp. 161-169, 2001.
114. L. Itti and C. Koch, “Computational modeling of visual attention,” Nature Reviews Neuroscience, vol. 2, no. 3, pp. 194-203, 2001.
115. L. Itti and C. Koch, “A saliency-based search mechanism for overt and covert shifts of visual attention,” Vision Research, vol. 40, no. 10, pp. 1489-1506, 2000.
116. V. Navalpakkam and L. Itti, “Modeling the Influence of task on attention,” Vision Research, vol. 45, pp. 205-231, 2005.
117. A. R. Damasio, “Fundamental Feelings,” Nature, pp. 413:781, 2001.
118. A. R. Damasio, “The brain binds entities and events by multiregional activation from convergence zones,” Neural Computation, vol. 1, pp. 123-132, 1989.
119. J. E. LeDoux, “Emotional memory systems in the brain,” Behavioral Brain Research, vol. 58, pp. 69-79, 1993.
120. J. E. LeDoux, Synaptic Self—How Our Brains Become Who We Are, Penguin Books, 2003.

121. O. Hikosaka, “Role of Basal Ganglia in control of innate movements, learned behavior and cognition—a hypothesis,” In G. Percheron, J. S. McKenzie and J. Feger (Eds), The Basal Ganglia, IV, New York, Plenum Press, pp. 589-595, 1994.
122. F. A. Middleton and P. L. Strick, “Anatomical evidence for cerebellar and basal ganglia involvement in higher cognitive function,” Science, vol. 166, 1377-1379, 1994.
123. K. Sakai, O. Hikosaka, S. Miyauchi, R. Takino, Y. Sasaki and B. Putz, “Transition of brain activation from frontal to parietal areas in visuomotor sequence learning,” Journal of Neuroscience, vol. 18, pp. 1827-1840, 1998.
124. S. Grossberg and W. Gutowski, “Neural dynamics of decision making under risk: Affective balance and cognitive-emotional interactions,” Psychological Review, vol. 94, pp. 300-318, 1987.
125. J. Brown, D. Bullock, and S. Grossberg, “How the basal ganglia use parallel excitatory and inhibitory learning pathways to selectively respond to unexpected rewarding cues,” Journal of Neuroscience, vol. 19, pp. 10502-10511, 1999.
126. J. C. Dessing, C. E. Peper, D. Bullock, and P. J. Beek, “How Position, Velocity, and Temporal Information Combine in Prospective Control of Catching: Data and Model,” Journal of Cognitive Neuroscience, vol. 17, no. 4, pp. 1-19, 2005.
127. D. Bullock, J. C. Fiala and S. Grossberg, “A neural model of timed response learning in the cerebellum,” Neural Networks, vol. 7, pp. 1104-1114, 1994.
128. S. Grossberg, S. and J. W. L. Merrill, “A neural network model of adaptively timed reinforcement learning and hippocampal dynamics,” Cognitive Brain Research, vol. 1, pp. 3-38, 1992.
129. S. Grossberg, “On the dynamics of operant conditioning,” Journal of Theoretical Biology, vol. 33, pp. 225-255, 1971.
130. S. Grossberg, “A neural theory of punishment and avoidance II: Quantitative theory,” Mathematical Biosciences, vol. 15, pp. 253-285, 1972.
131. S. Grossberg, “A neural model of attention, reinforcement, and discrimination learning,” International Review of Neurobiology, vol. 18, pp. 263-327, 1975.
132. S. Grossberg, “Processing of expected and unexpected events during conditioning and attention: A psychophysiological theory,” Psychological Review, vol. 89, pp. 529-572, 1982.
133. L. P. Pavlov, Conditioned Reflexes, Oxford University Press, 1927.
134. L. J. Kamin, “Predictability, surprise, attention, and conditioning,” in Punishment and Aversive Behavior,” pp. 279-298, 1969.
135. J. E. R. Staddon, Adaptive Behavior and Learning, Cambridge University Press, 1983.
136. S. Grossberg, The adaptive brain, Volumes I and II, Amsterdam: Elsevier/North-Holland, 1987.
137. S. Grossberg, and N. A. Schmajuk, “Neural dynamics of Pavlovian conditioning: Conditioned reinforcement, inhibition, and opponent processing,” Psychobiology, vol. 15, pp. 195-240, 1987.
138. S. Grossberg, and N. A. Schmajuk, “Neural dynamics of adaptive timing and temporal discrimination during associative learning,” Neural Networks, vol. 2, pp. 79-102, 1989.
139. S. Grossberg, “The link between brain learning, attention and consciousness,” Consciousness and Cognition, vol. 8, pp. 1-44, 1999.
140. S. T. Grafton, A. H. Fagg, R. P. Woods, and M. A. Arbib, “Functional anatomy of pointing and grasping in humans,” Cerebral Cortex, vol. 6, pp. 226-237, 1996.
141. S. T. Grafton, M. A. Arbib, L. Fadiga, and G. Rizzolatti, “Localization of grasp representations in humans by PET: 2. Observation compared with imagination,” Exploratory Brain Research, vol. 112, pp. 103-111, 1996.
142. M. Arbib and G. Rizzolatti, “Neural expectations: a possible evolutionary path from manual skills to language,” Communication and Cognition, vol. 29, pp. 393-424, 1997. [Reprinted in Ph. Van Loocke (ed.) The nature, representation and evolution of concepts, London/New York: Routledge].
143. G. Rizzolatti, and M. A. Arbib, “Language within our grasp,” Trends in Neuroscience, vol. 21, no. 5, pp. 188-194, 1998.
144. M. A. Arbib and M. Bota, “Language evolution: Neural homologies and neuroinformatics,” Neural Networks, vol. 16, no. 9, pp. 1237-1260, 2003.
145. M. A. Arbib, “The Mirror System Hypothesis: How did protolanguage evolve?,” In Maggie Tallerman, editor, Language Origins: Perspectives on Evolution. Oxford University Press, 2005.
146. R. S. Belvin, Inside Events: The non-possessive meanings of possession predicates and the semantic conceptualization of events. Ph.D. dissertation, USC, (available through UMI), 1996.
147. R. S. Belvin, “The two causative haves are the two possessive haves,” Proceedings of the 29th Annual Conference of the Chicago Linguistics Society, University of Chicago, Chicago Linguistics Society, 1993.
148. R. S. Belvin, and M. D. den Dikken, “There, happens, to, be, have,” Lingua, vol. 101, pp. 151-183, 1995.
149. S. Grossberg, “A psychophysiological theory of reinforcement, drive, motivation, and attention,” Journal of Theoretical Neurobiology, vol. 1, pp. 289-369, 1982.
150. S. Grossberg and D. S. Levine, “Neural Dynamics of Attentionally Modulated Pavlovian Conditioning: Blocking, Inter-Stimulus, Interval and Secondary Reinforcement,” Applied Optics, vol. 26, pp. 5015-5030, 1987.
151. J. L. Contreras-Vidal, J. L., S. Grossberg, and D. Bullock, “A neural model of cerebellar learning for arm movement control: Cortico-spino-cerebellar dynamics,” Learning & Memory, vol. 3, pp. 475-502, 1997.
152. M. A. Arbib, P. Érdi, and J. Szentágothai, Neural Organization: Structure, Function, and Dynamics, Cambridge, Mass., MIT Press, 1998.
153. The Handbook of Brain Theory and Neural Networks (MIT Press, 1995, 2003), Editor M. Arbib.
154. N. Srinivasa and R. Sharma, “SOIM: A self-organizing invertible map with applications in active vision,” IEEE Trans. on Neural Networks, vol. 7, no. 3, pp. 758-773, May 1997.
155. S. Grossberg and C. W. Myers, “The resonant dynamics of speech perception: Interword integration and duration-dependent backward effects,” Psychological Review, (4), 735-767, 2000.
156. S. Grossberg, “A psychophysiological theory of reinforcement, drive, motivation, and attention,” Journal of Theoretical Neurobiology, vol. 1, 289-369, 1982.
157. J. R. Anderson, Rules of the Mind. Hillsdale, N.J.: Lawrence Erlbaum Associates.
158. Laird, J. E., Newell, A., & Rosenbloom, P. S. (1987). SOAR: An architecture for general intelligence. Artificial Intelligence, 33, 1-64.
159. R. Hecht-Nielsen, A theory of Thalamocortex. Computational Models for Neuroscience—Human Cortical Information Processing. R. Hecht-Nielsen and T. McKenna, Springer, 2003.
160. A. Lansner, “Detailed Simulation of Large Scale Neural Networks”, Computational Neuroscience: Trends in Research 1997, J. M. Bower. Boston, Mass., Plenum Press: 931-935, 1997.

161. O. Sporns, R. Kötter, “Motifs in Brain Networks” PLoS Biology 2, 1910-1918, 2004.
162. J. Anderson, “A Brain Like Computer for Cognitive Applications: The Ersatz Brain Project”, Powerpoint file, http://www.cog brown.edu/Research/ErsatzBrainGroup/presentations.html.

(2.1) Glossary

Before describing the specific details of the present invention, a glossary is provided in which various terms used herein and in the claims are defined. The glossary provided is intended to provide the reader with a general understanding of the intended meaning of the terms, but is not intended to convey the entire scope of each term. Rather, the glossary is intended to supplement the rest of the specification in more accurately explaining the terms used.

Adaptive Resonance Theory—The term “Adaptive Resonance Theory” (ART) is used for stable construction of declarative and procedural memory within the sensory and cognitive processes based on “winner-take-all” and distributed computational mechanisms. Stable learning implies that the system can retain (not forget) large amounts of knowledge.

Adaptive Timing Circuits—The “adaptive timing circuits” refers to the interactions between the sensory and cognitive processes with spatial and motor processes via adaptive timing circuits to enable stable construction of action plans that lead to cognitive behaviors. The adaptively timed circuits can function at both micro and macro time scales, thereby providing the ability to enact a wide range of plans and actions for a continuously changing environment.

Complementary Computing—The term “complementary computing” refers to complementary pairs of parallel processing streams, wherein each stream's properties are related to those of a complementary stream (e.g., the “What” and “Where” streams). Complementary computing is needed to compute complete information to solve a given modal problem (e.g., vision, audition, sensory-motor control). Hierarchical and parallel interactions between the streams can resolve complementary deficiencies.

Instruction Means—The term “instruction means” as used with respect to this invention generally indicates a set of operations to be performed on a computer, and may represent pieces of a whole program or individual, separable, software modules. Non-limiting examples of “instruction means” include computer program code (source or object code) and “hard-coded” electronics (i.e. computer operations coded into a computer chip). The “instruction means” may be stored in the memory of a computer or on a computer-readable medium such as a floppy disk, a CD-ROM, and a flash drive.

Laminar Computing—The term “laminar computing” refers to a unified laminar format for the neural circuits that is prevalent in the various regions of the cerebral cortex. It is organized into layered circuits (usually six main layers) that undergo characteristic bottom-up, top-down, and horizontal interactions. Its ubiquity means that the basic function of the cortex is independent of the nature of the data that it is processing. Specializations of interactions in different modalities realize different combinations of properties, which points to the possibility of developing Very Large-Scale Integration (VLSI) systems.

Linking Affordances and Actions—The term “linking affordances and actions” refers to extracting general brain operating principles (BOPs) from studies of visual control of eye movements and hand movements, and the linkage of imitation and language. It also refers to the integration of parietal “affordances” (perceptual representation of possibilities for action) and frontal “motor schemas” (coordinated control programs for action) and subsequent interactions.

Spatio-Temporal Pattern Learning—The term “spatio-temporal pattern learning” refers to working memory models such as STORE and TOTEM for stable construction of temporal chunks or events that will be used to construct plans and episodic memory. STORE refers to a Sustained Temporal Order Recurrent network, as described in literature reference no. 110. TOTEM refers to a Topological and Temporal Correlator network, as described in literature reference no. 88. Temporal chunking allows multimodal information fusion capability. This is used for storage of event information and construction of stable action plans.

Topographic Organization—The term “topographic organization” refers to organizations that are observed in both the sensory (e.g., retina, cochlea) and motor cortex, where world events that are neighbors (in some sense) are also represented in neighboring patches of the cortex. The topographic organization has strong implications for the details of connectivity within given brain areas, in particular, as it emphasizes local connectivity over long-range connectivity

(2.2) Table of Acronyms

The present invention uses several analogies to anatomical structures and pathways, many of which are abbreviated for brevity. The abbreviations and their corresponding definitions of the anatomical structures/pathways are as follows: THAL=Thalamus; SC=Somatosensory Cortex; AC=Auditory Cortex; VC=Visual Cortex; NC=Neocortex; MC=Motor Cortex; TC=Temporal Cortex; PC=Parietal Cortex; PFC=Prefrontal Cortex; HS=Hippocampal System; HT=Hypothalamus; CC=Cingulate Cortex; PLC=Prelimbic Cortex; AM=Amygdala; BG=Basal Ganglia; CBL=Cerebellum; and SCL=Superior Colliculus.

### (3) PRINCIPAL ASPECTS

The present invention has three “principal” aspects. The first is a learning system. The learning system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

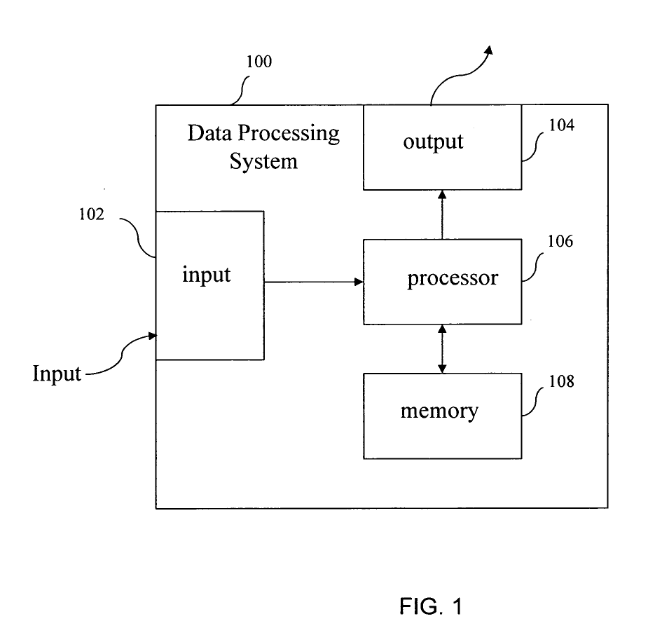

A block diagram depicting the components of the learning system of the present invention is provided in FIG. 1. The learning system 100 comprises an input 102 for receiving information from at least one sensor for use in detecting an object and/or event. Note that the input 102 may include multiple “ports.” Typically, input is received from at least one sensor, non-limiting examples of which include video image sensors. An output 104 is connected with the processor for providing action information or other information regarding the presence and/or identity of object(s) in the scene to other systems in order that a network of computer systems may serve as a learning system. Output may also be provided to other devices or other programs; e.g., to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software that are to be manipulated by commands to the processor 106.

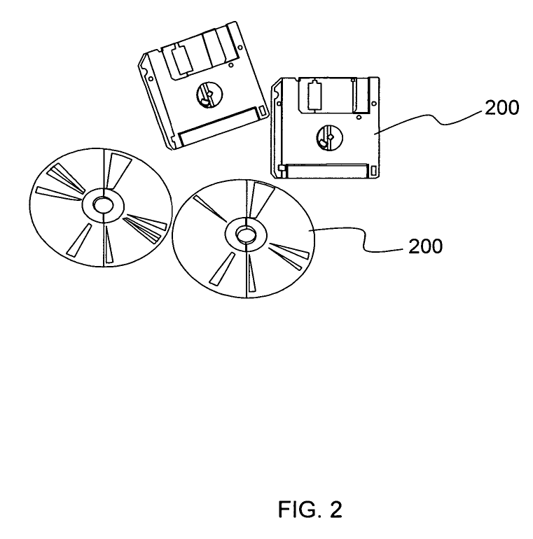

An illustrative diagram of a computer program product embodying the present invention is depicted in FIG. 2. The computer program product 200 is depicted as an optical disk such as a CD or DVD. However, as mentioned previously, the computer program product generally represents computer-readable instructions stored on any compatible computer-readable medium.

### (4) INTRODUCTION

The present invention relates to a learning system, such as an artificial intelligence (AI) system. The traditional approach to machine intelligence pursued by the AI community has provided many achievements, but has fallen short of the grand vision of integrated, versatile, intelligent systems. Revolutionary advances may be possible by building upon new approaches inspired by cognitive psychology and neuroscience. Such approaches have the potential to assist the understanding and modeling of significant aspects of intelligence thus far not attained by classic formal knowledge modeling technology.

This invention addresses the design and development of computational models of human cognition based on cognitive architectures that have the potential to surpass existing AI technologies in realizing truly intelligent and adaptive systems. Thus, the present invention is a Biologically-Inspired Cognitive Architecture for integrated Learning, Action and Perception (BICA-LEAP). BICA-LEAP is a novel neuroscience-inspired comprehensive architecture that seamlessly integrates perception, memory, planning, decision-making, action, self-learning and affect to address the full range of human cognition. One of the limitations of neurally-inspired brain architectures of the prior art is that they tend to solve modal problems (e.g., visual object recognition, audition, motivation, etc.) in disparate architectures whose design embodies specializations for each modal problem.

BICA-LEAP is based on the concept of brain operating principles and computational paradigms to realize structural, functional and temporal modularity and also integrate the various neural processes into a unified system that can exhibit a wide range of cognitive behaviors. A single comprehensive architecture that covers the full range of human cognition provides a basis for developing cognitive systems that can not only successfully function in a wide range of environments, but also thrive in new environments. The present invention and its adaptive, self-organizing, hierarchical architecture and integration methodology can lead to practical computational models that scale with problem size. Additionally, the present invention includes a framework to implement computational models of human cognition that could eventually be used to simulate human behavior and approach human cognitive performance in a wide range of situations. The BICA-LEAP can be integrated into a variety of applications and existing systems, providing support or replacement for human reasoning and decision-making, leading to revolutionary use in a variety of applications. Non-limiting examples of such applications include exploration systems, intelligence gathering/analysis, autonomous systems, cognitive robots, smart sensors, etc.

As briefly described above, an improvement over the prior art is that the present invention provides a single comprehensive architecture based on core Brain Operating Principles (BOPs) and Computational Paradigms (CPs) that realize structural, functional and temporal modularity. The present invention also integrates the various neural processes into a unified system that can exhibit wide range of cognitive behaviors to solve modal problems. The architecture of the present invention is fully distributed in its structure and functional capabilities and lends itself to practical computational architectures. It is an inherently nonlinear and parallel architecture that offers a powerful alternative to the probabilistic and linear models of traditional AI-based systems.

The comprehensive architecture of the present invention addresses all of the issues described above in the background section. It also provides a representation of complex information in forms that make it easier to perform inference and organized self-learning that makes it applicable to various domains without extensive programming or reprogramming. It can therefore be the basis of future efforts to simulate and develop truly cognitive systems as well as interface to conventional AI systems for application in diverse domains (e.g., augmenting human performance across a range of intelligence domains).

Such a single comprehensive architecture that covers the full range of human cognition provides a basis for developing cognitive systems that not only successfully function in a wide range of environments, but also thrive in new environments.

### (5) DETAILS OF THE INVENTION

One of the limitations of neurally-inspired brain architectures that has been characterized to date is that they tend to solve modal problems (visual object recognition, audition, motivation, etc.) in disparate architectures whose design embodies specializations for each modal problem. The present invention provides a single comprehensive architecture based on core Brain Operating Principles (BOPs) and Computational Paradigms (CPs) that can be adapted to all these problems. This architecture is fully distributed in its structure and functional capabilities. One of its key BOPs is complementary processing which postulates several complementary and hierarchically interacting processing streams and sub regions that cooperate and compete in parallel. This interaction helps overcome informational uncertainty in order to solve problems in perception and learning. One key CP of the architecture is laminar computing which postulates a uniform layered format/structure for neural circuitry in various brain regions. This CP offers a unique and explicit formulation of the brain's approach to reusable computing with sharing of neural resources for perception and action. Yet another key theme of the present invention is that the brain has evolved to carry out autonomous adaptation in real-time to a rapidly changing and complex world. Use of Adaptive Resonance Theory (ART) as an underlying mechanism in the architecture of the present invention explains this autonomous adaptation. This architecture also integrates learning mechanisms, adaptively timed neural circuits, and reinforcement-learning based neural circuits that model emotional and motivational drives to explain various cognitive processes, including reasoning, planning, and action. The above key BOPs and CPs enable the present invention to control a flexible repertoire of cognitive behaviors that are most relevant to the task at hand. These characteristics are realized using an inherently nonlinear and parallel architecture and offers a powerful alternative to the probabilistic and linear models of traditional Artificial Intelligence (AI)-based systems.

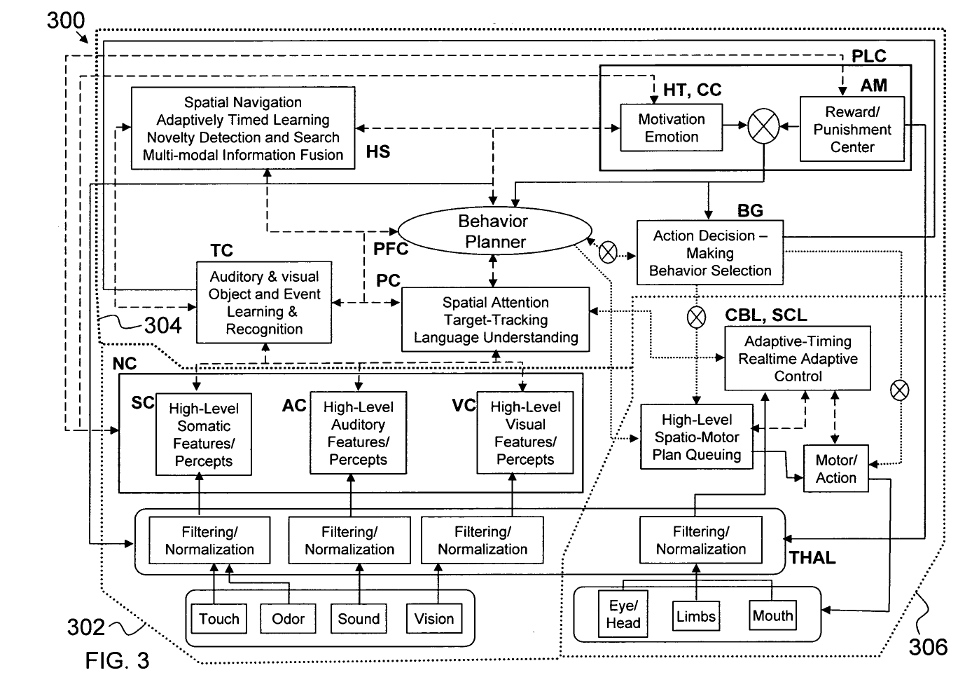

The architecture of the present invention is described as modules or systems that correspond to various cognitive and motor features. As shown in FIG. 3, the system 300 includes three basic modules, a sensory and perception module 302, a cognitive module 304, and an execution module 306. The large dashed arrows indicate a distributed set of links between any two structural entities to perform match learning (based on ART like circuits, described below) while the small dotted arrows indicate a distributed set of links between any two structural entities to perform mismatch learning (described below).

The modules are described by providing an account of functional roles at various stages as data is processed from the “bottom” to the “top” of the cortex. At the lowest level of the architecture is the sensory and perception module 302. The sensory and perception module 302 includes a set of peripheral sense organs including vision, auditory, and somatosensory sensors to sense the state of the external world. In other words, the sensory and perception module 302 is configured to receive and process external sensory input[s] from an external world and extract sensory-specific features from the external sensory input. The cognitive module 304 is configured to receive the sensory-specific features and identify a current context based on the sensory-specific features. Based on the current context and features, the cognitive module 304 learns, constructs, or recalls a set of action plans. The cognitive module 304 then evaluates the set of action plans against any previously known action plans in a related context. Based on the evaluation, the cognitive module 304 selects the most appropriate action plan given the current context. Finally, the execution module 306 is configured to carry out the action plan. The execution module 306 includes motor organs to perform actions based on the perception of the world, including occulomotor (eyes to saccade and fixate on targets), articulomotor (mouth to produce speech), and limbs (to move, reach for objects in space, grasp objects, etc.). For clarity, each of the basic modules and their corresponding sub-modules will be described in turn.

(5.1) Sensory and Perception Module

The sensory and perception module 302 generates and processes external sensory inputs from an external world and extracts sensory-specific features from the external sensory inputs.

(5.1.1) Preprocessing

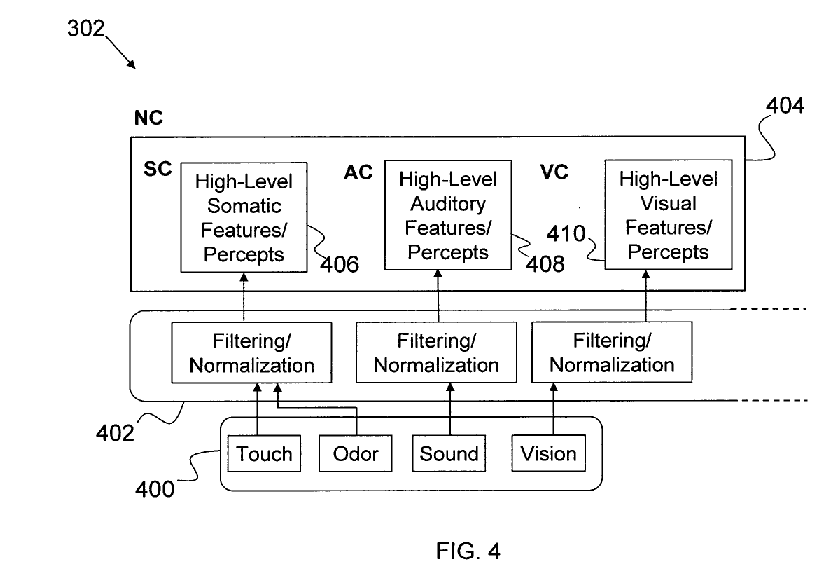

FIG. 4 is an illustration of the architecture for the sensory and perception module 302. As shown in FIG. 4, at the input level, the information input rate is limited by the spatial and temporal sampling rate of the sensors 400. Samples are best taken at high rates to gather maximum information. This generates a large amount of data, only a small fraction of which is relevant in any one situation. In order to extract useful information from this data, a pre-processing step is first initiated. During this step, the incoming data (external sensory inputs) for each modality (e.g., somatic sensor, auditory sensor, visual sensor) is filtered and normalized in a separate specialized circuit within a thalamus module 402 (THAL) (e.g., lateral geniculate nucleus (LGN) for vision (parvocellular and magnocellular divisions (see literature reference nos. 1, 2, 3, 4, 13, and 14))). These functions are realized via cooperative-competitive interactions (on-center off-surround) within the thalamus module 402. This helps in preserving the relative sizes and, hence, relative importance of inputs and thereby helps overcome noise and saturation (described as the noise-saturation dilemma in literature reference no. 24). Each modality is filtered and normalized using any suitable technique for filtering and normalizing external sensory inputs, a non-limiting example of which includes using the technique described by S. Grossberg in literature reference no. 136.

(5.1.2) Perception

The next step in processing is to abstract relevant information from the filtered and normalized input data. This abstraction process is initiated in a neocortex module 404 (NC) and propagates throughout cognitive module. The neocortex module 404 extracts sensory-specific features from the external sensory inputs (after they have been filtered and/or normalized by the thalamus module 402). The neocortex module 404 includes a somatic cortex (SC) module 406, an auditory cortex (AC) module 408, and a visual cortex (VC) module 410. The SC module 406 extracts somatic features from the scene, such as touch and odor. Additionally, the AC module 408 extracts auditory features, while the VC module 410 extracts visual features.

The neocortex module 404 is a modular structure that has the ability to integrate information from a remarkably diverse range of sources: bottom-up signals stemming from the peripheral sense organs; top-down feedback carrying goal related information from higher cortical areas (as explained later); and intrinsic horizontal signals carrying contextual information from neighboring regions within the same cortical area. These three distinct types of signals not only coexist within a single cortical area, but also interact and mutually shape each other's processing (see literature reference nos. 25 and 26).

The present invention addresses these interactions based on laminar computing (see literature reference nos. 8 and 9). Laminar computing concerns the fact that the cerebral cortex, the seat of all higher biological intelligence in all modalities, is organized into layered cortical circuits (usually six main layers) with characteristic bottom-up, top-down, and horizontal interactions. Specializations of these interactions in the different cortical areas realize different combinations of properties. Thus, the layered cortical circuit that “processes information” in the sensory cortex of a human when his/her hand is touched is the same circuit that “processes information” in the frontal cortex of a human when it thinks about a calculus problem. This incredible ubiquity means that the basic function of cortex is independent of the nature of the data that it is processing. The existence of such a unified laminar format for many different tasks also points to the possibility of developing very large-scale integration (VLSI) systems for intelligent understanding and control.

In the present invention, the notion of perception for different modalities is realized by integrating lower level features into a coherent percept within the neocortext module 404. This integration process is incorporated using the idea of complementary processing streams. In the present architecture, several processing stages combine to form a processing stream much like that in the brain. These stages accumulate evidence that realize a process of hierarchical resolution of informational uncertainty. Overcoming informational uncertainty utilizes both hierarchical interactions within the stream and the parallel interactions between streams that overcome their complementary deficiencies. For example, visual perception of form in the present architecture occurs via an ensemble of processing stages that interact within and between complementary processing streams. Boundary and surface formation illustrate two key principles of this capability (see literature reference nos. 3 and 4). The processing of form by the boundary stream uses orientationally tuned cells (see literature reference no. 27) to generate emergent object representations as supported by several psychophysical and neurophysiological experiments (see literature reference no. 28). Precise orientationally-tuned comparisons of left eye and right eye inputs are used to compute sharp estimates of the relative depth of an object from its observer (see literature reference nos. 29 and 30), and thereby to form three-dimensional boundary and surface representations of objects separated from their backgrounds (see literature reference no. 31). Similarly, there exist such complementary properties in the form-motion interactions (see literature reference nos. 32 and 34) of the architecture for visual perception of moving objects. The orientationally-tuned form system that generates emergent representations of forms with precise depth estimates is complementary to the directionally-tuned motion system that can generate only coarse depth estimates on its own (see literature reference nos. 33 and 38).

(5.2) Cognitive Module

As described above, the cognitive module receives the sensory-specific features, identifies a current context, and ultimately selects the most appropriate action plan given the current context. The cognitive module utilizes several sub-modules to select the most appropriate action plan.

(5.2.1) Learning and Attention: What, Where, and How

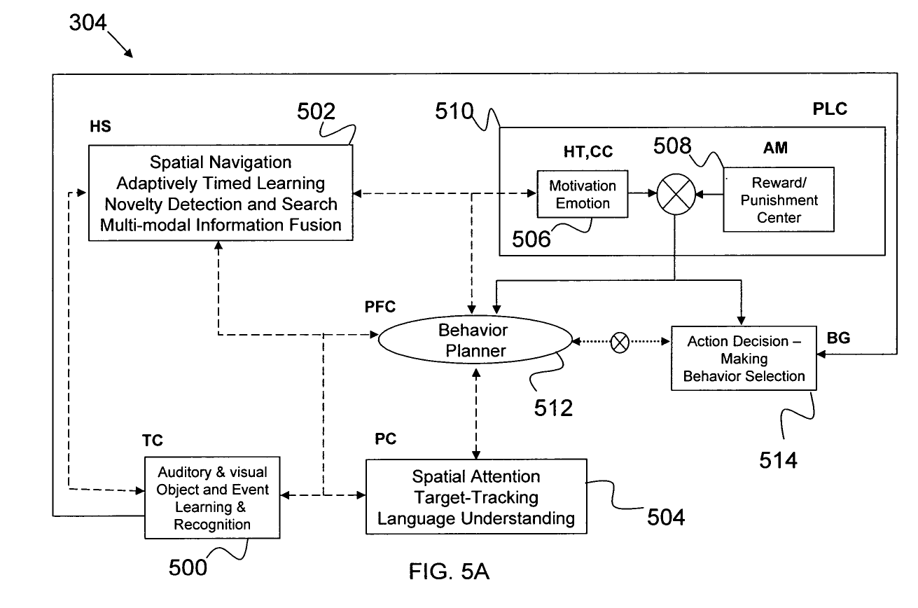

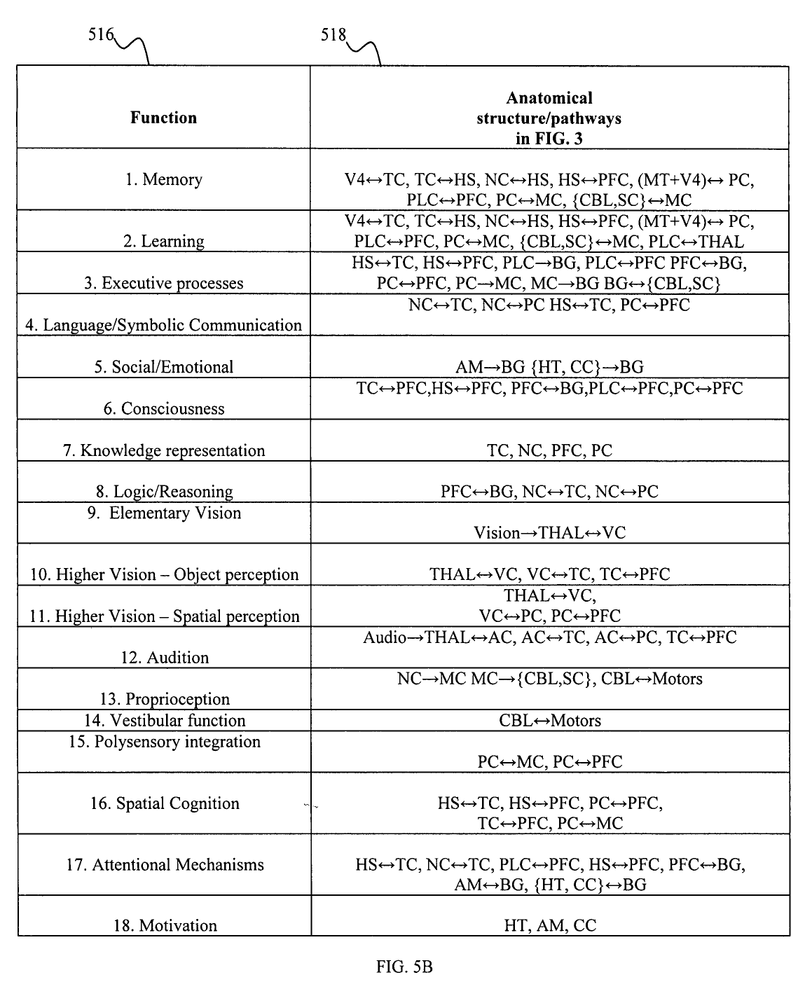

In the present invention, the complementary form and motion processing is part of a larger design for complementary processing whereby objects in the world are cognitively recognized, spatially localized, and acted upon. As shown in FIG. 5A, the object and event learning system 500 learns to categorize and recognize what objects are in the world (i.e., declarative memory or memory with record). In other words, the object and event learning system 500 is configured to use the sensory-specific features to classify the features as objects and events. The object and event learning system 500 operates as a classification system, non-limiting examples of which include using the techniques described by G. Bradski and S. Grossberg; and G. A. Carpenter, S. Grossberg, and G. W. Lesher, in literature reference nos. 104 and 39 respectively.

Another module, the novelty detection, search, and navigation module 502 (described below) determines if the sensory-specific features match previously known events and objects by comparing the sensory-specific features against features corresponding to known objects and events. If there is no match, then the object and event learning system 500 stores the features as new objects and events. Alternatively, if there is a match, then the object and event learning system 500 stores the features as updated features corresponding to known objects and events. The object and event learning system 500 is analogous to the inferotemporal cortex (TC) and its cortical projections in a human's brain. As can be appreciated by one skilled in the art, the TC is the object and event learning system 500 and the TC is referred to herein interchangeably with the said system 500.

The object and event learning system 500 is to be contrasted with the spatial representation module 504, which learns to determine where the objects are and how to deal with them by locating them in space (i.e., procedural memory or memory without record), tracking them through time (i.e., when) and directing actions toward them (see literature reference nos. 7, 35, 36, and 37). The spatial representation module 500 is configured to establish space and time attributes for the objects and events. The spatial representation module 500 uses any suitable device or technique for establishing space and time attributes given objects and/or events; a non-limiting example of such a technique includes using the technique as described by G. A. Carpenter, S. Grossberg, and G. W. Lesher in literature reference no. 39.

The spatial representation module 504 transmits the space and time attributes to the novelty detection, search, and navigation module 502. The novelty detection, search, and navigation module 502 is also configured to use the space and time attributes to construct a spatial map of the external world. The novelty, detection, search, and navigation module 502 constructs a spatial map using any suitable technique for converting space and time attributes into a spatial map, non-limiting examples of which include the techniques described by S. Grossberg and J. W. L. Merrill; G. A. Carpenter and S. Grossberg; G. A. Carpenter and S. Grossberg; and G. A. Carpenter and S. Grossberg, in literature reference nos. 23, 42, 43, and 44 respectively.

The novelty detection, search, and navigation module 502 is analogous to the Hippocampal System (HS), and as can be appreciated by one skilled in the art, the HS is referred to herein interchangeably with the said module 502. Additionally, the spatial representation module 504 is analogous to the parietal cortex (PC) and its cortical projections in a human's brain, and as can be appreciated by one skilled in the art, the PC is referred to herein interchangeably with the module 504.

The cortical projections (mentioned above) are realized using ART circuits within the architecture of the present invention (dashed lines between modules in FIGS. 3 through 6) (see literature reference nos. 6, 39, 40, and 42-46). These circuits are supported by neurophysiological data (see literature reference nos. 41 and 51). Additionally, variants of ART have been used in several technological applications (see literature reference nos. 56-92). ART circuits facilitate complementary interactions between the attentional subsystem (in the TC) and the spatial representation module 504 or the novelty detection, search, and navigation module 502 (see literature reference nos. 23, 47-50, and 51-55). The ART circuits enable the present invention to discover and stably learn new representations for novel objects in an efficient way, without assuming that representations already exist for as yet unseen objects.

In the present invention, auditory and speech percepts are emergent properties that arise from the resonant states of the ART circuits. For example, the present invention can use ARTSTREAM (see literature reference no. 19) to separate distinct voices (such as those in a cocktail party environment) into distinct auditory streams. Resonant dynamics between a spectral stream level at which frequencies of the sound spectrum are represented across a spatial map, and the pitch stream level that comprise a given pitch helps separate each auditory stream into a unique spatial map. Similarly, resonant waves between bottom-up working memory that represents the individual speech items and a top-down list categorization network that groups the individual speech items into learned language units or chunks is modeled in ARTPHONE (described in literature reference no. 15) to realize phonemic restoration properties.

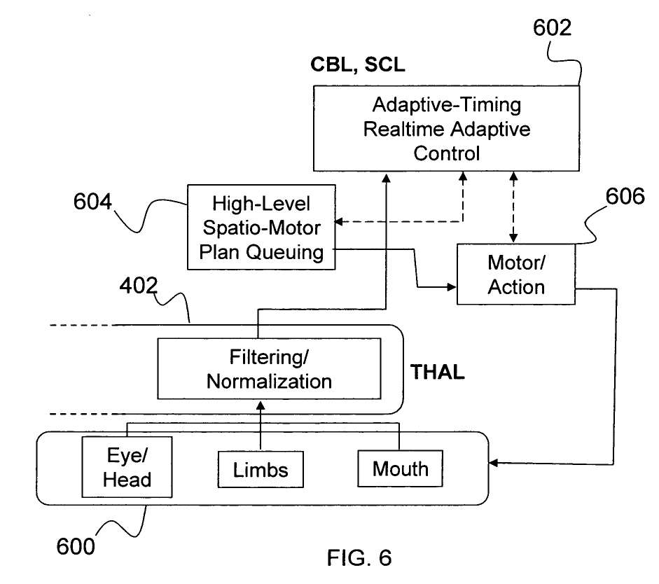

In addition to what and where streams, there is a how processing stream that operates in parallel and provides the capability to take actions based on the sensed world. First, as shown in FIG. 6, the signals from the muscles that control the motors 600 are filtered in the thalamus module 402. In order to effectively realize its actions (such as visually guided reaching of targets or grasping), the system uses the how stream to map the spatial representation of targets in the PC into a head-centered representation (see literature reference no. 93) and eventually a body-centered representation (see literature reference no. 94). This representation is invariant under rotations of the head and eyes (e.g., sensors such as a camera). Intrastream complementarity (see literature reference nos. 95-97) occurs during this process wherein vergence of the two eyes/cameras, as they fixate on the object, is used to estimate the object's radial distance, while the spherical angles that the eyes make relative to the observer's head estimate the object's angular position. The head-centered representation of targets is used to form a spatial trajectory from the current position to the target position.

The inverse kinematics problem is solved when the spatial trajectory is transformed into a set of joint angle commands (see literature reference no. 98) via information available during action-perception cycles. The inverse dynamics problem is solved by the invariant production of commanded joint angle time courses despite large changes in muscle tension (see literature reference no. 99).

Similarly, neural circuits exist in the architecture to model other modalities, such as the act of speaking that utilizes perceptual information from the auditory cortex during action perception cycles (see literature reference no. 10). These neural circuits with a unified format learn all these sensory-motor control tasks based on interactions between the PC, the motor cortex (MC) module (described below), the external valuation module (described below), and the cerebellum (CBL) module (described below). For these “basic” sensory-motor control tasks, the architecture of the present invention does not need to know what that target is. It relates to the target object as a set of possible affordances (see literature reference no. 100) or opportunities for reaching and grasping it. The ideas from literature reference no. 100 are integrated with the models postulated in literature reference nos. 101 and 102 to achieve reaching and grasping properties.

(5.2.2) Spatio-Temporal Learning

In higher cortical areas, as the signals move higher up in complexity space, time differences in neuronal firing induced by the input patterns become important. These higher areas model the relationships between high-level representations of categories in various modalities using temporal information (such as temporal order of objects/words/smells in the TC). The present architecture achieves this temporal learning capability using a combination of ART category learning, working memories, associative learning networks, and predictive feedback mechanisms (see literature reference nos. 103-110) to learn event categories.

As shown in FIG. 5A, the prefrontal cortex (PFC) serves as a working memory (see literature reference no. 111) where information converges from multiple sensory modalities which interacts with subcortical reward mechanisms (as in the amygdala (AM) module 506 and hypothalamus (HT) module 508 of the internal valuation module 510 (described below)) to sustain an attentional focus upon salient event categories. The PFC is analogous to the behavior planner module 512, and as can be appreciated by one skilled in the art, the PFC is referred to herein interchangeably with the said module 512. Essentially, the behavior planner module 506 is configured to receive information about the objects and events, the space and time attributes for the objects and events, and the spatial map. The behavior planner module 506 uses those inputs to learn, construct, or recall a set of action plans. Additionally, the behavior planner module 506 uses the status of the internal state (provided by the internal valuation module 510) to sub-select the most appropriate action from the set of action plans.

Multimodal information distributed across the PFC is integrated using ART (see literature reference no. 57) that is designed to selectively reset input channels with predictive errors and also selectively pay attention (ignore) to event categories that have high (low) salience due to prior reinforcement. The interactions between the TC and the PFC are a type of macro-timing process that integrates information across a series of events. The architecture of the present invention models the TC-HS interactions as a type of micro-timing process using an adaptive timing model that controls how cognitive-emotional and sensory-motor interactions are coordinated (see literature reference nos. 129-138) based on the interactions of the sensory representations (in TC), the drive representations (in the internal valuation module 510), and the motor representations (in the external valuation module 514 and the cerebellum (CBL) module). The motor representations also contribute to the modulation of declarative memory by motivational feedback and to the learning and performance of procedural memory.

The present invention is also capable of exhibiting complex task-driven visual behaviors for the understanding of scenes in the real world (see literature reference nos. 14, and 112-116). Given a task definition, the architecture of the present invention first determines and stores the task-relevant/salient entities in working memory, using prior knowledge stored in the long-term memory of ART circuits. For a given scene, the model then attempts to detect the most relevant entity by biasing its visual attention with the entity's learned low-level features. It then attends to the most salient location in the scene and attempts to recognize the object (in the TC) using ART circuits that resonate with the features found in the salient location. The system updates its working memory with the task-relevance of the recognized entity and updates a topographic task relevance map (in the PC) with the location of the recognized entity. The stored objects and task-relevance maps are subsequently used by the PFC to construct predictions or plans for the future.

For more complex sensory-motor coordination tasks such as speaking and language understanding, the present invention capitalizes on the unified format of the above mentioned neural circuitry. The present invention integrates the PC and the coordinated control plans for action (or frontal motor schemas), including the PC's interaction with recognition (TC), planning (PFC) and behavioral control systems (external valuation module) (see literature reference nos. 140-148). This architecture is grounded in the use of mechanisms of vocal, facial and manual expressions that are rooted in the human's praxic interactions with the environment (see literature reference no. 19). The present invention incorporates spatial cues to aid audition/speech comprehension (see literature reference no. 155), temporal chunking (see literature reference no. 107), phonemic restoration (see literature reference no. 15) and speech production models (see literature reference nos. 10 and 11).

(5.2.3) Emotion and Motivation

Because humans are physiological beings, humans have basic motivations that demand satisfaction (e.g., eating, drinking, sleeping, etc.). Each behavior can either satisfy or not satisfy one of these motivations. The present invention includes an internal valuation module 510 to mimic basic human motivations. The internal valuation module 510 is configured to evaluate the value of the sensory-specific features and the context. For example, the internal valuation module values the sensory-specific features and context such that they are modeled mathematically to have a value in a range between zero and one, where zero is the least valuable and one is the most valuable. An example of such a technique was described by J. W. Brown, D. Bullock, and S. Grossberg in literature reference no. 18.

The internal valuation module is also configured to generate a status of internal states of the system and given the context, associate the sensory-specific features to the internal states as either improving or degrading the internal state. As a non-limiting example, the system is incorporated into a mobile robot. The robot determines that it is currently raining and that it is wet. Based on its knowledge of electrical systems, the robot determines that it would be best to seek cover to avoid the rain. Since the robot is currently traveling in a direction away from cover, the robot determines that to continue in its current trajectory will increase its wetness (or time being wet), and thereby degrade its internal state (increasing its wetness which is contrary to its desire to be dry).

In other words, when an ongoing behavior/perceptual state enters the prelimbic cortex (PLC) (see literature reference nos. 117 and 118) as an input, a correlated emotional response is generated. The PLC is analogous in function to the internal valuation module 510, and as can be appreciated by one skilled in the art, the PLC is referred to herein interchangeably with the said module 510.

The internal valuation module 510 includes two sub-modules, the AM module 508 and the HT module 506. The AM module 508 is a reward/punishment center that generates a reward or punishment for certain actions. The rewards or punishments are defined as valuations of the internal state of the system and whether or not certain actions degrade or improve the internal state. The HT module 506 learns to correlate these behavior patterns with feedback signals to the behavior planner module 512 and the novelty detection, search, and navigation module 502 that map the sensory representations using ART circuits. Emotions are produced in response to behaviors that impact currently active actions or motivational drives. Each cortical plan/prediction of behavior (from the behavior planner module 512) enters the internal valuation module 510 as spatio-temporal patterns that produce as output the emotional reaction to each plan. The output of the behavior planner module 512 describes what is going to happen, while the output of the internal valuation module 510 describes what should happen. Mismatches between the behavior planner module 512 and the internal valuation module 510 are used by the external valuation module 514 to compute expected utility of the currently active action plan based on the models as set forth in literature reference nos. 121-124, and 150. If the mismatch is large, then the external valuation module 514 will inhibit (attentional blocking of) the current behavior (action plan) and a new one is selected.

In other words, the external valuation module 514 is configured to establish an action value based purely on the objects and events. The action value is positively correlated with action plans that are rewarding to the system based on any previously known action plans. The external valuation module 514 is further configured to learn from the positive correlation to assess the value of future action plans and scale a speed at which the action plans are executed by the execution module (element 306 in FIGS. 3 and 6). Finally, the external valuation module 514 is configured to open a gate in a manner proportional to the action value such that only action plans that exceed a predetermined action value level are allowed to proceed to the execution module 306.

In the architecture of the present invention, this inhibition is modeled as an on-center off-surround within the external valuation module 514, as illustrated in literature reference no. 125. This will enable the architecture to model decision making for complex spatial and motor processes, such as planned eye/camera saccades (see literature reference no. 18) and control of catching a target object (see literature reference no. 126). Once the decision to act is made by the external valuation module 514, the complex motor sequences for the selected or contextually appropriate behaviors/plan (available in the behavior planner module 512) are reinforced at the internal valuation module 510. As shown in FIG. 6, the selected motor plans are used by a timing control module 602 to execute a set of adaptively-timed actions (movements) until the goal is reached, as outlined in literature reference nos. 23, 127, and 128.

For further illustration, FIG. 5B is a table mapping various cognitive functionalities with structures and pathways as related to the architecture illustrated in FIG. 3. The first column lists a cognitive function 516, while the second column lists the corresponding anatomical structure/pathway 518 that caries out the cognitive function 516. As can be appreciated by one skilled in the art, the present invention includes a system, method, and computer program product that is configured to perform the various cognitive functions 516 using a corresponding module/pathway.

(5.3) Execution Module

As described above and shown in FIG. 6, the execution module 306 is configured to carry out the action plan. Actions are manifested in the form of motor plans (action plans), non-limiting examples of which include running, yelling, etc. The selected action plans are used by the CBL and SC to execute a set of adaptively timed actions (movements) until the goal is reached. Here the CBL serves as an organ for adaptive control real-time control circuits that can use the information about the evolving sensory-perceptual context, and about errors in realization of the desired goal to continually correct itself until the desired goal state is achieved.

More specifically, the execution module 306 includes a queuing module 604 to receive the action plans and order them in a queue sequentially according to their action value. Additionally, the timing control module 602 determines the speed at which to execute each action plan. A motor/action module 606 is included that integrates the order and speed at which to execute the action plans. The motor/action module 606 then sends a signal to the corresponding motor 600 to sequentially execute the action plans according to the order of the queue and the determined speed. Based on the sequential execution, the timing control module 602 learns the timing of the sequential execution for any given action plan in order to increase efficiency when executing similar action plans in the future.

(5.4) Consciousness

In the architecture of the present invention, all resonant states are conscious states (see literature reference nos. 139 and 156). If a particular region (module) is strongly resonating with the bottom-up stimuli, the system is more conscious of those events. Any learned spatio-temporal pattern is determined partly by bottom-up data and partly by top-down selection. The degree to which the system is conscious of particular actions is determined by how much the representation was formed by top-down selection (in the TC, HS, and PFC) or degree of resonance, as opposed to being determined by bottom-up data. Thus, firing patterns in sensory and cognitive areas that are directly selected (by attention) have the most meaning in the architecture and it is most conscious of its activity at that time. When the models described above are combined into the comprehensive system architecture for intelligent behavior, the sensory and cognitive match-based networks in the What processing stream provide self-stabilizing representations with which to continually learn more about the world without undergoing catastrophic forgetting. The Where/How processing stream's spatial and motor mismatch-based maps and gains can continually forget their old parameters in order to instate the new parameters that are needed to control the system in its present form. Since the spatial and motor or procedural memory processes are often based on inhibitory matching, it does not support excitatory resonance and hence cannot support consciousness in the architecture. The complementary match and mismatch learning mechanisms within this larger architecture combined with the adaptive timing circuits that mediate their interactions illustrates how circuits in the self-stabilizing match-based sensory and cognitive parts of the brain can resonate into consciousness (see literature reference nos. 139 and 156), even while they are helping to direct the contextually appropriate activation of spatial and motor circuits to perform cognitive actions. The mechanisms that unify these effects within the architecture are inherently nonlinear and parallel and offer a powerful alternative to the probabilistic and linear models currently in use.

### (6) SUMMARY OF KEY FEATURES

The architecture of the present invention provides a unique perspective on the higher-level principles of computation in neural systems, including the interplay of feedforward, feedback and lateral pathways. The present invention offers a unique and explicit formulation of the brain's approach to reusable computing with sharing of neural resources for perception and action. The present invention is a system that employs general-purpose learning mechanisms inspired by biology that provide self-stabilizing representations for the sensory and cognitive processes of the brain to continually learn more about the world without undergoing catastrophic forgetting of concepts already learned from the past. At the same time, the present invention employs learning mechanisms to enable the spatial and motor circuits to continually calibrate the parameters that are needed to control the system in its present form. These complementary learning mechanisms are integrated with adaptively timed neural circuitry and modulated by reinforcement-learning-based neural circuits that model emotion and motivational drives to perform cognitive functions, including reasoning, planning and actions.

What is claimed is:

1. A learning system, comprising:
a sensory and perception module operative to receive and process an external sensory input from an external world and extract sensory-specific features from the external sensory input;
a cognitive module operative to receive the sensory-specific features and identify a current context based on the sensory-specific features, and, based on the current context and features, learn, construct, or recall a set of action plans and evaluate the set of action plans against any previously known action plans in a related context and, based on the evaluation, selecting the most appropriate action plan given the current context; and
an execution module operative to carry out the action plan.

2. A learning system as set forth in claim 1, wherein the cognitive module further comprises an object and event learning system and a novelty detection, search, and navigation module, where the object and event learning system is operative to use the sensory-specific features to classify the features as objects and events, and where the novelty detection, search, and navigation module is operative to determine if the sensory-specific features match previously known events and objects, and if they do not match, then the object and event learning system stores the features as new objects and events, and if they do match, then the object and event learning system stores the features as updated features corresponding to known objects and events.

3. A learning system as set forth in claim 2, wherein the cognitive module further comprises a spatial representation module, the spatial representation module operative to establish space and time attributes for the objects and events, the spatial representation module operative to transmit the space and time attributes to the novelty detection, search, and navigation module, with the novelty detection, search, and navigation module being operative to use the space and time attributes to construct a spatial map of the external world.

4. A learning system as set forth in claim 3, wherein the cognitive module further comprises an internal valuation module to evaluate a value of the sensory-specific features and the current context, the internal valuation module being operative to generate a status of internal states of the system and given the current context, associate the sensory-specific features to the internal states as improving or degrading the internal state.

5. A learning system as set forth in claim 4, wherein the cognitive module further comprises an external valuation module, the external valuation module being operative to establish an action value based purely on the objects and events, where the action value is positively correlated with action plans that are rewarding to the system based on any previously known action plans, and where the external valuation module is operative to learn from the positive correlation to assess the value of future action plans and scale a speed at which the action plans are executed by the execution module.

6. A learning system as set forth in claim 5, wherein the cognitive module further comprises a behavior planner module that is operative to receive information about the objects and events, the space and time attributes for the objects and events, and the spatial map to learn, construct, or recall a set of action plans, and use the status of the internal state to sub-select the most appropriate action from the set of action plans, and where the external valuation module is operative to open a gate in a manner proportional to the action value such that only action plans that exceed a predetermined action value level are allowed to proceed to the execution module.

7. A learning system as set forth in claim 6, wherein the execution module is operative to:
receive the action plans and order them in a queue sequentially according to their action value;
receive inputs to determine the speed at which to execute each action plan;
sequentially execute the action plans according to the order of the queue and the determined speed; and
learn the timing of the sequential execution for any given action plan in order to increase efficiency when executing similar action plans in the future.

8. A learning system as set forth in claim 7, further comprising a motor for carrying out the action plan.

9. A learning system as set forth in claim 1, wherein the sensory and perception module includes a sensor for sensing and generating the external sensory inputs, wherein the sensor is selected from a group consisting of a somatic sensor, an auditory sensor, and a visual sensor.

10. A learning system as set forth in claim 1, wherein the execution module is operative to:
receive the action plans and order them in a queue sequentially according to their action value;
receive inputs to determine the speed at which to execute each action plan;
sequentially execute the action plans according to the order of the queue and the determined speed; and
learn the timing of the sequential execution for any given action plan in order to increase efficiency when executing similar action plans in the future.

11. A learning system as set forth in claim 1, further comprising a motor for carrying out the action plan.

12. A learning system as set forth in claim 1, wherein the cognitive module further comprises an internal valuation module to evaluate a value of the sensory-specific features and the current context, the internal valuation module being operative to generate a status of internal states of the system and given the current context, associate the sensory-specific features to the internal states as improving or degrading the internal state.

13. A computer program product for learning, the computer program product comprising computer-readable instruction means stored on a computer-readable medium that are executable by a computer for causing the computer to:
receive and process an external sensory input from an external world and extract sensory-specific features from the external sensory input;
receive the sensory-specific features and identify a current context of a system based on the sensory-specific features, and, based on the current context and features, learn, construct, or recall a set of action plans and evaluate the set of action plans against any previously known action plans in a related context and, based on the evaluation, selecting the most appropriate action plan given the current context; and
execute out the action plan.

14. A computer program product as set forth in claim 13, further comprising computer-readable instruction means that are executable by a computer for causing the computer to:
use the sensory-specific features to classify the features as objects and events; and
determine if the sensory-specific features match previously known events and objects, and if they do not match, then store the features as new objects and events, and if they do match, then store the features as updated features corresponding to known objects and events.

15. A computer program product as set forth in claim 14, further comprising computer-readable instruction means that are executable by a computer for causing the computer to:
establish space and time attributes for the objects and events; and
use the space and time attributes to construct a spatial map of the external world.

16. A computer program product as set forth in claim 15, further comprising computer-readable instruction means that are executable by a computer for causing the computer to:
evaluate a value of the sensory-specific features and the current context; and
generate a status of internal states of the system and given the current context, associate the sensory-specific features to the internal states as improving or degrading the internal state.

17. A computer program product as set forth in claim 16, further comprising computer-readable instruction means that are executable by a computer for causing the computer to:
establish an action value based purely on the objects and events, where the action value is positively correlated with action plans that are rewarding to the system based on any previously known action plans; and
learn from the positive correlation to assess the value of future action plans and scale a speed at which the action plans are executed.

18. A computer program product as set forth in claim 17, further comprising computer-readable instruction means that are executable by a computer for causing the computer to:
receive information about the objects and events, the space and time attributes for the objects and events, and the spatial map to learn, construct, or recall a set of action plans, and use the status of the internal state to sub-select the most appropriate action from the set of action plans; and
open a gate in a manner proportional to the action value such that only action plans that exceed a predetermined action value level are allowed to proceed to being executed.

19. A computer program product as set forth in claim 18, further comprising computer-readable instruction means that are executable by a computer for causing the computer to:
receive the action plans and order them in a queue sequentially according to their action value;
receive inputs to determine the speed at which to execute each action plan;
sequentially execute the action plans according to the order of the queue and the determined speed; and
learn the timing of the sequential execution for any given action plan in order to increase efficiency when executing similar action plans in the future.

20. A computer program product as set forth in claim 19, further comprising computer-readable instruction means that are executable by a computer for causing the computer to cause a motor to execute the action plan.

21. A computer program product as set forth in claim 13, further comprising computer-readable instruction means that are executable by a computer for causing the computer to sense and generate the external sensory inputs using a sensor that is selected from a group consisting of a somatic sensor, an auditory sensor, and a visual sensor.

22. A computer program product as set forth in claim 13, further comprising computer-readable instruction means that are executable by a computer for causing the computer to:
receive the action plans and order them in a queue sequentially according to their action value;
receive inputs to determine the speed at which to execute each action plan;
sequentially execute the action plans according to the order of the queue and the determined speed; and
learn the timing of the sequential execution for any given action plan in order to increase efficiency when executing similar action plans in the future.

23. A computer program product as set forth in claim 13, further comprising computer-readable instruction means that are executable by a computer for causing the computer to cause a motor to execute the action plan.

24. A computer program product as set forth in claim 13, further comprising computer-readable instruction means that are executable by a computer for causing the computer to:
evaluate a value of the sensory-specific features and the current context; and
generate a status of internal states of the system and given the current context, associate the sensory-specific features to the internal states as improving or degrading the internal state.

25. A method for learning, comprising acts of:
receiving and processing an external sensory input from an external world and extracting sensory-specific features from the external sensory input;
receiving the sensory-specific features and identifying a current context of a system based on the sensory-specific features, and, based on the current context and features, learning, constructing, or recalling a set of action plans and evaluating the set of action plans against any previously known action plans in a related context and, based on the evaluation, selecting the most appropriate action plan given the current context; and
executing out the action plan.

26. A method as set forth in claim 25, further comprising acts of:
using the sensory-specific features to classify the features as objects and events; and
determining if the sensory-specific features match previously known events and objects, and if they do not match, then storing the features as new objects and events, and if they do match, then storing the features as updated features corresponding to known objects and events.

27. A method as set forth in claim 26, further comprising acts of:
establishing space and time attributes for the objects and events; and
using the space and time attributes to construct a spatial map of the external world.

28. A method as set forth in claim 27, further comprising acts of:
evaluating a value of the sensory-specific features and the current context; and
generating a status of internal states of the system and given the current context, associate the sensory-specific features to the internal states as improving or degrading the internal state.

29. A method as set forth in claim 28, further comprising acts of:
establishing an action value based purely on the objects and events, where the action value is positively correlated with action plans that are rewarding to the system based on any previously known action plans; and
learning from the positive correlation to assess the value of future action plans and scale a speed at which the action plans are executed.

30. A method as set forth in claim 29, further comprising acts of:
receiving information about the objects and events, the space and time attributes for the objects and events, and the spatial map to learn, construct, or recall a set of action plans, and use the status of the internal state to sub-select the most appropriate action from the set of action plans; and
opening a gate in a manner proportional to the action value such that only action plans that exceed a predetermined action value level are allowed to proceed to being executed.

31. A method as set forth in claim 30, further comprising acts of:
receiving the action plans and order them in a queue sequentially according to their action value;
receiving inputs to determine the speed at which to execute each action plan;
sequentially executing the action plans according to the order of the queue and the determined speed; and
learning the timing of the sequential execution for any given action plan in order to increase efficiency when executing similar action plans in the future.

32. A method as set forth in claim 31, further comprising acts of causing a motor to execute the action plan.

33. A method as set forth in claim 25, further comprising acts of sensing and generating the external sensory inputs using a sensor that is selected from a group consisting of a somatic sensor, an auditory sensor, and a visual sensor.

34. A method as set forth in claim 25, further comprising acts of:
receiving the action plans and order them in a queue sequentially according to their action value;
receiving inputs to determine the speed at which to execute each action plan;
sequentially executing the action plans according to the order of the queue and the determined speed; and
learning the timing of the sequential execution for any given action plan in order to increase efficiency when executing similar action plans in the future.

35. A method as set forth in claim 25, further comprising acts of causing a motor to execute the action plan.

36. A method as set forth in claim 25, further comprising acts of:
evaluating a value of the sensory-specific features and the current context; and
generating a status of internal states of the system and given the current context, associate the sensory-specific features to the internal states as improving or degrading the internal state.
